(19) United States
(12) Patent Application Publication
(10) Pub. No.: US 2008/0126641 A1
(43) Pub. Date: May 29, 2008

(54) Methods and Apparatus for Combining Commands Prior to Issuing the Commands on a Bus

(76) Inventors: John D. Irish, Rochester, MN (US); Chad B. McBride, Rochester, MN (US)

Correspondence Address: IBM Corporation;Intellectual Property Law Dept. 917, 3605 Hwy. 52 North, Rochester, MN, 55901, US

(21) Appl. No.: 11/468,889

(22) Filed: Aug. 31, 2006

(51) Int. Cl. G06F 13/00

(52) U.S. Cl. 710/112

(57) ABSTRACT

In a first aspect, a first method of issuing a command on a bus is provided. The first method includes the steps of (1) receiving a first command associated with a first address; (2) delaying the issue of the first command on the bus for a time period; (3) if a second command associated with a second address contiguous with the first address is not received before the time period elapses, issuing the first command on the bus after the time period elapses; and (4) if the second command associated with the second address contiguous with the first address is received before the first command is issued on the bus, combining the first and second commands into a combined command associated with the first address. Numerous other aspects are provided.

### FIELD OF THE INVENTION

The present invention relates generally to processors, and more particularly to methods and apparatus for combining commands prior to issuing the commands on a bus.

### BACKGROUND

In a conventional system, a first processor may be coupled to a second processor by an input/output (I/O) interface. The first processor may receive commands, which are to be placed on a bus, from the second processor via the I/O interface. The first processor may split the received commands into a read command stream and a write command stream, store read commands in a read queue and store write commands in a write queue.

A conventional system may maintain order between the command streams by determining whether a read command at the top of the read queue depends on completion of a pending write command and/or whether a write command at the top the write queue depends on completion of a pending read command. More specifically, the conventional system employs a read address collision list to track addresses associated with pending read commands and a write address collision list to track addresses associated with pending write commands.

The conventional system may maintain a first matrix indicating dependence of read commands on write commands. The first matrix may be populated by data output from the write address collision list when indexed by respective read commands. Similarly, the conventional system may maintain a second matrix indicating dependence of write commands on read commands. The second matrix may be populated by data output from the read address collision list when indexed by respective write commands. The conventional system may employ the dependency matrices and address collision lists to determine whether a command at the top of the read queue depends on a write command and/or whether a command at the top of the write queue depends on a read command.

The I/O interface typically transfers commands of a first size (e.g., 128 Bytes) from the second processor to the first processor. However, the bus may transfer commands up to a second, larger size (e.g., 256 Bytes) thereon. Therefore, transmitting commands of the first size on the bus may inefficiently consume system resources (e.g., bus bandwidth). Accordingly, improved methods and apparatus for issuing a command on a bus are desired.

### SUMMARY OF THE INVENTION

In a first aspect of the invention, a first method of combining commands prior to issuing a command on a bus is provided. The first method includes the steps of (1) receiving a first command associated with a first address; (2) delaying the issue of the first command on the bus for a time period; (3) if a second command associated with a second address contiguous with the first address is not received before the time period elapses, issuing the first command on the bus after the time period elapses; and (4) if the second command associated with the second address contiguous with the first address is received before the first command is issued on the bus, combining the first and second commands into a combined command associated with the first address.

In a second aspect of the invention, a first apparatus for combining commands prior to issuing a command is provided. The first apparatus includes (1) a bus; and (2) command pipeline logic coupled to the bus and adapted to (a) receive a first command associated with a first address; (b) delay the issue of the first command on the bus for a time period; (c) if a second command associated with a second address contiguous with the first address is not received before the time period elapses, issue the first command on the bus after the time period elapses; and (d) if the second command associated with the second address contiguous with the first address is received before the first command is issued on the bus, combine the first and second commands into a combined command associated with the first address.

In a third aspect of the invention, a first system for combining commands prior to issuing a command is provided. The first system includes (1) a first processor; and (2) a second processor coupled to the first processor and adapted to communicate with the first processor. The second processor includes an apparatus for issuing the command, having (a) a bus; and (b) command pipeline logic coupled to the bus and adapted to (i) receive a first command associated with a first address; (ii) delay the issue of the first command on the bus for a time period; (iii) if a second command associated with a second address contiguous with the first address is not received before the time period elapses, issue the first command on the bus after the time period elapses; and (iv) if the second command associated with the second address contiguous with the first address is received before the first command is issued on the bus, combine the first and second commands into a combined command associated with the first address. Numerous other aspects are provided, as are systems and apparatus in accordance with these other aspects of the invention.

Other features and aspects of the present invention will become more fully apparent from the following detailed description, the appended claims and the accompanying drawings.

### BRIEF DESCRIPTION OF THE FIGURES

FIGS. 1A-B illustrate a block diagram of a system adapted to combine two commands into a single command in accordance with an embodiment of the present invention.

FIG. 2 illustrates exemplary command combining and aging logic included in the system of FIG. 1 in accordance with an embodiment of the present invention.

### DETAILED DESCRIPTION

The present invention provides improved methods and apparatus for issuing a command on a bus. Similar to the conventional system described above, the present methods and apparatus may split read and write commands into streams, store read commands in a read queue and store write commands in a write queue. Further, the present methods and apparatus may employ conventional read and write address collision lists and dependency matrices to determine whether a command at the top of the read queue depends on a write command and/or whether a command at the top of the write queue depends on a read command. However, in contrast to the conventional system, the present methods and apparatus may include logic adapted to combine commands such that commands may be stored in a queue and issued on the bus efficiently. For example, the logic may assign an age to a first received command which is associated with a first address and may be of a first size. Such an age may advance at a predetermined age rate.

The age rate of the command may be based on the address associated with the first command. The logic may be adapted to determine whether the first command may be combined with a subsequently-received second command, which may be of the first size and is associated with a second address that is contiguous with the first address, before the first command reaches a predetermined maximum age. If so, the logic may combine the first and second commands into a single command which may be of a second size. Therefore, rather than store the first and second commands of the first size in two respective queue entries, the present methods and apparatus may store the combined command of the second size in a single queue entry. By combining commands in this manner, the present methods and apparatus may efficiently store commands in a queue. Further, rather than issuing the two commands (e.g., the first and second commands) of the first size separately on the bus, the present methods and apparatus may issue a single command (e.g., the combined command) on the bus. By combining commands in this manner, the present methods and apparatus may efficiently employ bus bandwidth. Alternatively, if the first command reaches the predetermined maximum age before the logic determines such command may be combined with a subsequently-received command, the present methods and apparatus may issue the first command on the bus. In this manner, the first command may not be delayed indefinitely in an effort to efficiently consume resources (e.g., bus bandwidth). Accordingly, the present invention provides improved methods and apparatus for issuing a command on a bus.

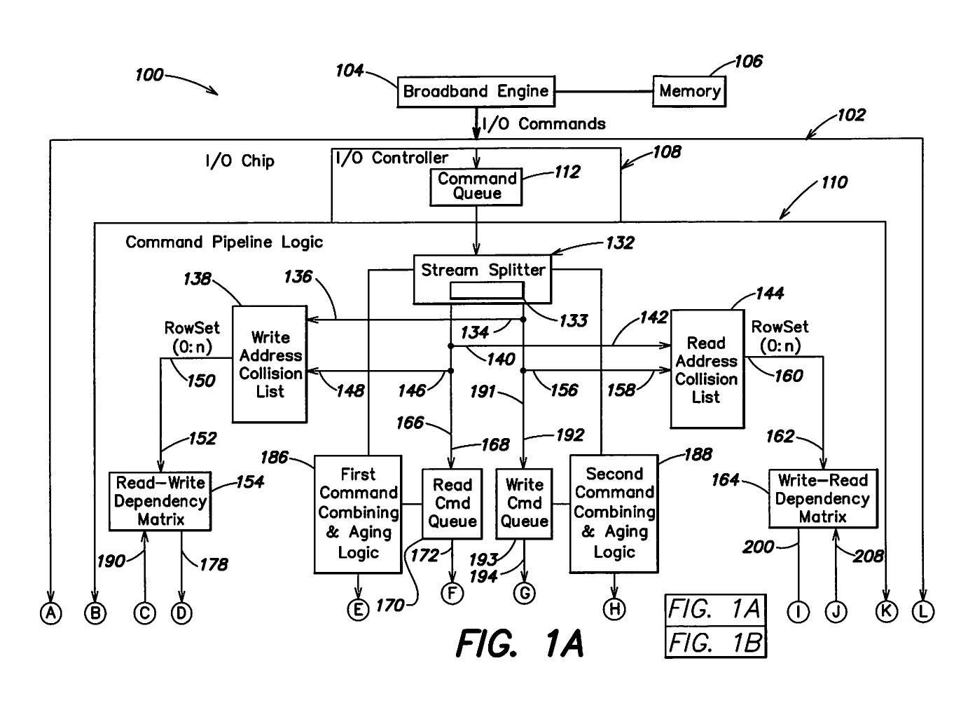

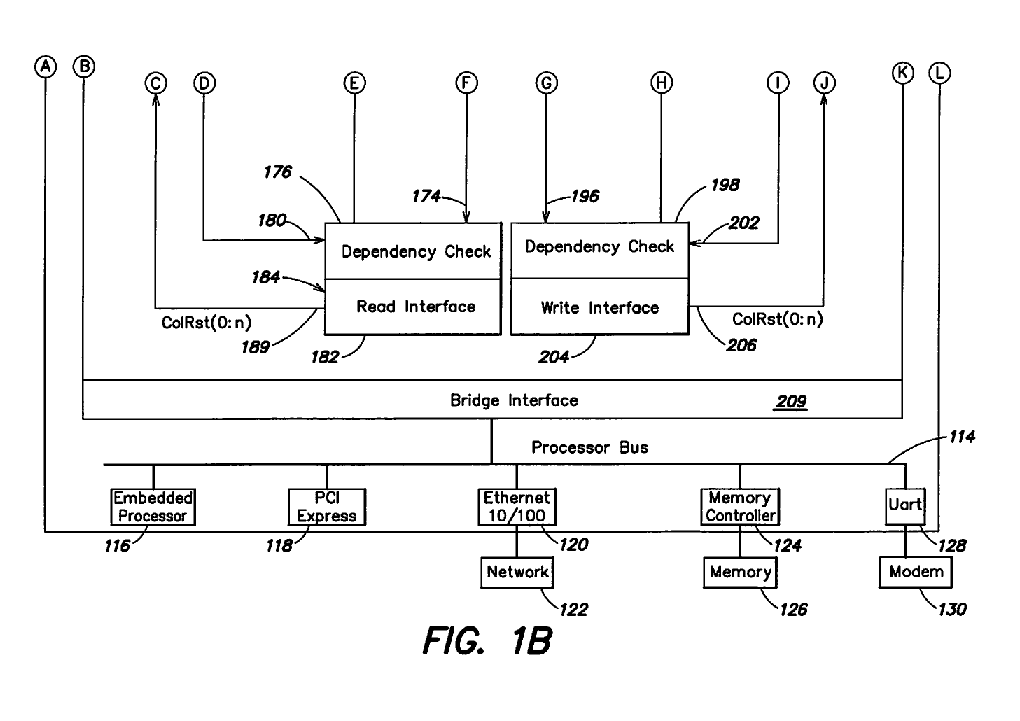

FIGS. 1A-B illustrate a block diagram of a system 100 adapted to combine two commands into a single command in accordance with an embodiment of the present invention. With reference to FIG. 1, the system 100 may include a first processor 102 coupled to a second processor 104, which may be coupled to a memory 106. The first processor 102 may be adapted to communicate with (e.g., receive commands, such as read and/or write commands for an I/O subsystem) from the second processor 104. For example, the first processor 102 may be an input/output (I/O) processor and the second processor 104 may be a main processor or CPU which issues commands to the first processor 102.

The first processor 102 may include an I/O interface 108 such as a controller coupled to command pipeline logic 110 (e.g., bus master logic). The I/O interface 108 may be adapted to receive commands from the second processor 104 and transmit such commands to the command pipeline logic 110. For example, the I/O interface 108 may be adapted to receive commands of a first size (e.g., 128-Byte commands) from the second processor 104. The I/O interface 108 may include a command queue 112 adapted to store the commands received from the second processor 104 and from which the commands are issued to the command pipeline logic 110.

The command pipeline logic 110 may be coupled to a bus (e.g., a processor bus) 114 on which the commands may be issued. In contrast to the I/O interface 108, the bus 114 may be adapted to receive commands of up to a second size (e.g., up to 256-Byte commands) that is larger than the first size.

The command pipeline logic 110 may be adapted to determine and track address collision dependencies of the commands received thereby. More specifically, the command pipeline logic 110 may be adapted to determine whether an address associated with (e.g., targeted by) a received command is the same as an address associated with a previously-received command. Further, the command pipeline logic 110 may be adapted to efficiently store commands and issue such commands on the bus 114. More specifically, the command pipeline logic 110 may be adapted assign respective ages to received commands. Such ages may increment over time. A command may not be issued on the bus until the command matures (e.g., reaches a predetermined maximum age). Thereafter, the command may be issued on the bus 114. Further, the command pipeline logic 110 may be adapted to combine two or more commands (e.g., first and second commands), each of which may be of a first size, into a single command of a second, larger size such that the combined command may be stored efficiently by the command pipeline logic 110 and may be issued efficiently on the bus 114. The combined command may adopt the age of the first command. The command pipeline logic 110 may be adapted to issue commands on the bus 114 based on ages of the commands, respectively. Further, in some embodiments, the command pipeline logic 110 may issue commands on the bus based on address collision dependencies. Details of the command pipeline logic 110 are described below.

The bus 114 may be coupled to one or more components and/or I/O device interfaces through which an address associated with a command may be accessed. For example, the bus 114 may be coupled to a processor 116 embedded in the first processor 110. Additionally, the bus 114 may be coupled to a PCI Express card 118 adapted to couple to a PCI bus (not shown). Further, the bus 114 may couple to a network card 120 (e.g., a 10/100 Mbps Ethernet card) through which the first processor 110 may access a network 122, such as a wide area network (WAN) or local area network (LAN). Additionally, the bus 114 may couple to a memory controller (e.g., a Double Data Rate (DDR2) memory controller) 124 through which the first processor 110 may couple to a second memory 126. Also, the bus 114 may couple to a Universal Asynchronous Receiver Transmitter (UART) 128 through which the first processor 110 may couple to a modem 130. The above connections to the bus 114 are exemplary. Therefore, the bus 114 may couple to a larger or smaller amount of components or I/O device interfaces. Further, the bus 114 may couple to different types of components and/or I/O device interfaces. As described below the command pipeline logic 110 may efficiently store commands and issue commands on the bus 114 which may require access to a component and/or I/O device interface coupled to the bus 114.

The command pipeline logic 110 may include stream splitter logic 132 adapted to separate commands received by the first processor 102 into a stream of read commands and a stream of write commands. The stream splitter logic 132 may assign respective free read tags to received read commands and respective free write tags to received write commands (e.g., via free tag assignment logic 133 included therein). The tags may be employed to access components described below.

A first output 134 of the stream splitter logic 132 may be coupled to a first input 136 of a write address collision list 138. The write address collision list 138 may be similar to a contents-addressable memory (CAM) adapted to output data based on input data. The first input 136 of the write address collision list 138 may be employed to input entries for write commands and respective addresses associated therewith. In this manner, the write address collision list 138 may include entries corresponding to each received write command that is assigned a write tag.

Similarly, a second output 140 of the stream splitter logic 132 may be coupled to a first input 142 of a read address collision list 144. The read address collision list 144 may also be similar to a CAM adapted to output data based on input data. The first input 142 of the read address collision list 144 may be employed to input entries for read commands and respective addresses associated therewith. In this manner, the read address collision list 144 may include entries corresponding to each received read command that is assigned a read tag.

Further, a third output 146 of the stream splitter logic 132 may be coupled to a second input 148 of the write address collision list 138 such that an address associated with a read command may be input by the write address collision list 138. Based on such input, the write address collision list 138 may output one or more bits via a first output 150 thereof, which may be coupled to a first input 152 of a read-write dependency matrix 154. The bits may be stored as a row in the read-write dependency matrix 154 (e.g., in response to a row set command RowSet(0:n) by the command pipeline logic 110). Rows of the read-write dependency matrix 154 correspond to respective read tags may be assigned to read commands. Columns of the read-write dependency matrix 154 correspond to respective write tags that may be assigned to write commands. Thus, each column may correspond to a write command and indicate read commands that depend from the write command.

A fourth output 156 of the stream splitter logic 132 may be coupled to a second input 158 of the read address collision list 144 such that an address associated with a write command may be input by the read address collision list 144. Based on such input, the read address collision list 144 may output one or more bits via a first output 160 thereof, which may be coupled to a first input 162 of a write-read dependency matrix 164. In this manner, the bits may be stored as a row in the write-read dependency matrix 164 (e.g., in response to a row set command RowSet(0:n) by the command pipeline logic 110). Rows of the write-read dependency matrix 164 correspond to respective write tags that may be assigned to write commands. Columns of the write-read dependency matrix 164 correspond to respective read tags that may be assigned to read commands. Thus, each column may correspond to a read command and indicate write commands that depend from the read command.

Additionally, a fifth output 166 of the stream splitter logic 132 may be coupled to an input 168 of a queue 170 adapted to store the read commands. An output 172 of the read command queue 170 may be coupled to a first input 174 of first dependency check logic 176. Further, a first output 178 of the read-write dependency matrix 154 may be coupled to a second input 180 of the first dependency check logic 176. The first dependency check logic 176 may be adapted to determine whether dependencies associated with a received read command have cleared. More specifically, the first dependency check logic 176 may receive (e.g., via the second input 180 thereof) one or more bits of information indicating dependence of one or more read commands on write commands from the read-write dependency matrix 154 output from the first output 178 thereof. Based on such bits, the first dependency check logic 176 may determine whether dependencies associated with respective commands in the read queue have cleared. The first dependency check logic 176 may be coupled to a read interface 182 which forms a first portion of a bus interface 184 through which commands are issued to the bus 114.

Similarly, a sixth output 191 of the stream splitter logic 132 may be coupled to an input 192 of a queue 193 adapted to store the write commands. An output 194 of the write command queue 193 may be coupled to a first input 196 of second dependency check logic 198. Further, a first output 200 of the write-read dependency matrix 164 may be coupled to a second input 202 of the second dependency check logic 198. The second dependency check logic 198 may be adapted to determine whether dependencies associated with a received write command have cleared. More specifically, the second dependency check logic 198 may receive (e.g., via the second input 202 thereof) one or more bits of information indicating dependence of one or more write commands on read commands from the write-read dependency matrix 164 via the first output 200 thereof. Based on such bits, the second dependency check logic 198 may determine whether dependencies associated with respective commands in the write command queue 193 have cleared. The second dependency check logic 198 may be coupled to a write interface 204 which forms a second portion of the bus interface 184.

Additionally, the command pipeline logic 110 may include command combining and aging logic (e.g., first and second command combining and aging logic 186, 188). More specifically, the first command combining and aging logic 186 may be coupled to the stream splitter logic 132, the read command queue 170 and the bus 114 (e.g., via the read interface 182) and issue commands thereon. The first command combining and aging logic 186 may be adapted to receive read commands from the stream splitter logic 132, assign respective ages to received read commands, increment such ages over time and store such commands in the read command queue 170. Further, the first command combining and aging logic 186 may be adapted to combine two or more of the received read commands, each of which may be of a first size (e.g., 128 Bytes), into a single read command of a second larger size (e.g., 256 Bytes) such that the combined read command may be stored efficiently by the read command queue 170. Additionally, the first command combining and aging logic 186 may be adapted to issue a read command on the bus 114 after the read command matures (e.g., reaches a predetermined maximum age). In this manner, issuance of a read command on the bus 114 may be delayed but not indefinitely. By issuing a combined read command, which may be of the second size, the first command combining and aging logic 186 may efficiently employ bandwidth of the bus 114.

The command pipeline logic 110 may be adapted to select a command from the read command queue 170 based on respective ages of commands in the queue and/or based on address collision dependencies of the commands. For example, once a command that has reached maturity and/or that is not dependent on other commands is selected from the read command queue 170, such command may be provided to the read interface 182. The read interface 182 may update the read-write matrix 154 to update dependence of commands stored therein on the selected read command (e.g., via a column reset command ColRst(0:n) that updates bits associated with a write command indicating dependence of read commands thereon). For example, the column reset command may be output from the read interface 184 via a first output 189 thereof and input by a second input 190 of the read-write matrix 154.

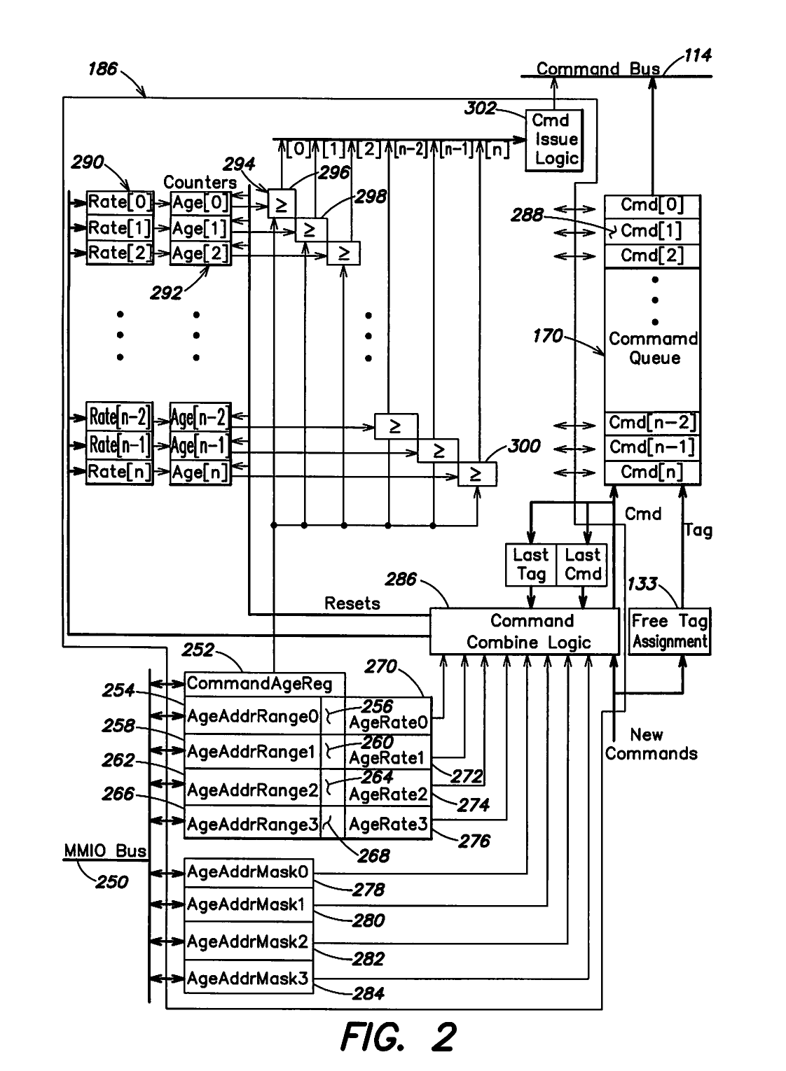

The second command combining and aging logic 188 may be coupled to the stream splitter logic 132, the write command queue 193 and the bus 114 (e.g., via the write interface 204) and may issue commands thereon. The second command combining and aging logic 188 may be adapted to receive write commands from the stream splitter logic 132, assign respective ages to received write commands, increment such ages over time and store such commands in the write command queue 193. Further, the second command combining and aging logic 188 may be adapted to combine two or more of the received write commands, each of which may be of a first size (e.g., 128 Bytes), into a single write command of a second larger size (e.g., 256 Bytes) such that the combined write command may be stored efficiently by the write command queue 193. Additionally, the second command combining and aging logic 188 may be adapted to issue a write command on the bus 114 after the write command matures (e.g., reaches a predetermined maximum age). In this manner, issuance of a write command on the bus 114 may be delayed but not indefinitely. By issuing a combined write command, which may be of the second size, the second command combining and aging logic 188 may efficiently employ bandwidth of the bus 114. Details of the command combining and aging logic 186, 188 are described below with reference to FIG. 2.

The command pipeline logic 110 may be adapted to select a command from the write command queue 193 based on respective ages of commands in the queue and/or based on address collision dependencies of the commands. For example, once a command that has reached maturity and/or that is not dependent on other commands is selected from the write command queue 193, such command may be provided to the write interface 204. The write interface 204 may update the write-read dependency matrix 164 to update dependence of commands stored therein on the selected write command (e.g., via a column reset ColRst(0:n) command that updates bits associated with a read command indicating dependence of write commands thereon). For example, the column reset command may be output from the write interface 204 via a first output 206 thereof and input by a second input 208 of the write-read dependency matrix 164. In some embodiments, the bus interface 184 may serve as an interface through which commands may be issued on the bus 114.

Thus, the present invention may provide an I/O processor 102 which may receive read, write, ensure in-order execution of I/O (eieio) and/or similar commands from another processor (e.g., CPU) via an I/O interface. The I/O processor 102 may buffer the commands and master the commands on to a bus 114 (e.g., a processor bus) from which the commands may be passed along to an appropriate device (e.g., PCI-express interface card or DDR2 memory controller). For example, to prevent unnecessary stalls or delays of the write commands while waiting for read commands to complete, the I/O processor may split received commands into separate read and write streams. Because commands are separated in this manner, command order should be maintained between the streams. Depending on interfaces involved and command target address, the ordering rules may range from strict to relaxed. Strict ordering states that the read and write commands must complete in the same order that they are issued from the CPU. Relaxed ordering states that read and write commands can pass each other if they are not targeting the same address space. However, another ordering rule may be employed. The ordering rule is passed along with the command as the command flows from the CPU. Ordering between the read and write streams is maintained using a dependency matrix 154, 164 for each stream and an address look-up list to calculate dependencies. Read commands may maintain order between themselves due to the nature of the read command queue. Thus, for read commands, dependency information on other types of in-flight commands (e.g., write commands) is maintained. Similarly, write commands may maintain order between themselves due to the nature of the write command queue. Thus, for write commands, dependency information on other types of in-flight commands (e.g., read commands) is maintained. As read and write commands reach the top of their respective queue, a dependency check is performed to see if there are any outstanding dependencies. If there are dependencies then the command and its respective queue is stalled until the dependency is cleared.

FIG. 2 illustrates exemplary command combining and aging logic included in the system of FIGS. 1A-B in accordance with an embodiment of the present invention. With reference to FIG. 2, the exemplary aging logic described below is the first command combining and aging logic 186, which is coupled to the read command queue 170. The first command combining and aging logic 186 may be coupled to a memory mapped input/output (I/O) bus 250 of the first processor 102. Further, the first command combining and aging logic 186 may be coupled to the bus 114, stream splitter logic 132 and read command queue 170. More specifically, the first command combining and aging logic 186 may include a command age register 252 adapted to store the predetermined maximum age that commands may reach after which the command may be issued on the bus 114. The logic 186 may include a plurality of age address range registers 254-268 adapted to define one or more address ranges. For example, a first pair 254, 256 of age address range registers may be adapted to define a first address range Age Address Range0 by storing first and last addresses, respectively, of the first address range. In a similar manner, a second pair 258, 260 of age address range registers may be adapted to define a second address range Age Address Range1, a third pair 262, 264 of age address range registers may be adapted to define a third address range Age Address Range2, and a fourth pair 266, 268 of age address range registers may be adapted to define a fourth address range Age Address Range3.

The logic 186 may include a plurality of age rate registers 270-276 that correspond to the age address range pairs 254-256, 258-260, 262-264, 266-268, respectively. The plurality of age rate registers 270-276 may be adapted to store age rates associated the address ranges defined by the pairs 254-256, 258-260, 262-264, 266-268. For example, a first age rate register 220 may be adapted to store an age rate Age Rate0 employed to age commands associated with an address in the first address range Age Address Range0. Similarly, a second age rate register 272 may be adapted to store an age rate Age Rate1 employed to age commands associated with an address in the second address range Age Address Range1, a third age rate register 274 may be adapted to store an age rate Age Rate2 employed to age commands associated with an address in the third address range Age Address Range2, and a fourth age rate registers 276 may be adapted to store an age rate Age Rate3 employed to age commands associated with an address in the fourth address range Age Address Range3.

The first processor 102 may receive commands associated with address on different byte boundaries, respectively. For example, the first processor may receive a first command associated with an address on a 256-Byte boundary and a second command associated with an address on a 128-Byte boundary. Therefore, the logic 186 may include a plurality of age address mask registers 278, 280, 282, 284 corresponding the age address ranges, respectively. Each age address mask register 278, 280, 282, 284 may store a value that serves to mask one or more bits of the addresses stored in a corresponding age address range register pair 254-256, 258-260, 262-264, 266-268 to form masked addresses. An address associated with a command may be compared with the masked version of addresses stored by the plurality of age address range registers 254-276 to determine the pair of registers 254-256, 258-260, 262-264, 266-268 that store an address range, the mask version of which includes the address associated with the command. The age rate register 270-276 corresponding to the age address range register pair 254-256, 258-260, 262-264, 266-268 stores the age rate employed to age the command. The MMIO bus 200 may be employed by a processor (e.g., the I/O processor 102) to set values stored in the registers 252-284. In this manner, command aging may be enabled/disabled and/or programmed via an MMIO access. Although four age address range pairs 254-256, 258-260, 262-264, 266-268, corresponding age rate registers 270-276 and age address mask registers 278-284 are described above, the logic 186 may include a smaller (or larger) number of age address range register pairs 254-256, 258-260, 262-264, 266-268, corresponding age rate registers 220-226 and/or age address mask registers 278-284 such that a smaller (or larger) number of address ranges, age rates and/or age address masks may be defined.

Additionally, the logic 186 may include command combine logic 286 coupled to the stream splitter logic 132. The command combine logic 286 may be adapted to receive a new command (e.g., a read command) and an address associated therewith (e.g., targeted thereby) from the stream splitter logic 132. Further, the free tag assignment logic 133 may be adapted to receive the new command and assign a free tag thereto. The command combine logic 286 (along with the free tag assignment logic 133) may be coupled to a command queue 170. In this manner, the command, and address and tag associated therewith may be stored in an entry 288 of the command queue 170 that corresponds to the tag. Additionally, the command combine logic 286 may be adapted to receive a previously-received command, and address and tag associated therewith as a feedback inputs. Based on such inputs (e.g., the new command, address and tag associated therewith, and the previously-received command, address and tag associated therewith), the command combine logic 286 may determine whether a new command may be combined with the previously-received command. Sequential commands may be combined if such commands are associated with contiguous addresses, respectively. For example, assume the previously-received command and new commands are both of the first size (e.g., 128 Bytes). If the previously-received command is associated with a first address defined on a first byte boundary (e.g., a 256-Byte boundary) and the new command is associated with a second address, which is contiguous with the first address, and is defined on a second byte boundary (e.g., 128-Byte boundary) that may be smaller than the first byte boundary, the commands may be combined. The combined command may be of a second size (e.g., 256 Bytes) and associated with the address and tag of the previously-received command.

To wit, if the command combine logic 286 determines the new command may be combined with the previously-received command, the size of the previously-received command, which is stored in the queue, may be updated (e.g., from 128 Bytes to 256 Bytes). By combining commands in this manner, the logic 186 may efficiently store data. For example, rather than storing the new command and previously-received command in separate queue entries 288, the logic may combine the new command and previously-received command and store the combined command in a single queue entry 288.

Additionally, the second size may be the maximum size of a command that may be received on the bus 114. Therefore, when the combined command is issued on the bus 114, such command efficiently employs bus bandwidth.

Further, the command combine logic 286 may be coupled to the age address range registers 254-268, age rate registers 270-276 and age address mask registers 278-284. Additionally, the logic 186 may include an age rate register corresponding to each tag (e.g., read tag) that may be associated with a received command. For example, assuming n+1 tags (e.g., tag0-tagn) may be assigned to received commands, the logic 186 may include n+1 age rate registers 290 adapted to store age rates Rate[0]-Rate[n] which correspond to the tags, and therefore, to commands Cmd[0]-Cmd[n] stored in entries 288 of the command queue 170. Similarly, the logic 186 may include counters 292 which correspond to the age rate registers 254. Each counter is adapted to track the age of a command stored in the queue 170. When the command combine logic 286 receives a command associated with an address, the logic 286 may determine an age rate AgeRate0-AgeRate3 for the command (e.g., based a masked version of the age address ranges). The command may be stored in a queue entry 288. Further, the command combine logic 286 may store the age rate Rate[0]-Rate[n] for the command in the age rate register 290 associated therewith. Further, the command combine logic 286 may reset (e.g., set to an initial age of “0”) the counter 292 associated the command. The first combining and aging logic 186 may increment the age of the command stored in the queue over time. For example, every cycle, the logic 186 may increment the age of the command stored in the queue 170 by the age rate.

Additionally, the logic 186 may include a first through n+1st compare logic 294 coupled to the counters 292, respectively. For example, first compare logic 296 may be coupled to the counter 292 corresponding to the first queue entry, second compare logic 298 may be coupled to the counter 292 corresponding to the second queue entry, and so on, such that the n+1st compare logic 300 may be coupled to the counter 292 corresponding to the n+1st queue entry. Additionally, the command age register 252 may be coupled to each compare logic 294 (e.g., first through n+1st compare logic 296-300).

Each compare logic 294 may be adapted to compare an age Age[0]-Age[n] input thereby with the predetermined maximum age stored in the command age register 252. If the age Age[0]-Age[n] input by the compare logic 294 is greater than or equal to the predetermined maximum age, the compare logic 294 may output a signal indicating the command associated with the age has matured, and therefore, may be removed from the queue and issued on the bus 114. Alternatively, if the age Age[0]-Age[n] input by the compare logic 294 is not greater than or equal to the predetermined maximum age, the compare logic 294 may output a signal indicating the command associated with the age has not matured, and therefore, may not be removed from the queue and issued on the bus 114. In this manner, such command may be delayed such that the command may possibly be combined with a subsequently-received command.

The logic 186 may include and/or be coupled to command issue logic 302 coupled to the first through n+1st compare logic 296-300 and the bus 114. The command issue logic 302 may receive the signals [0]-[n] output from the first through n+1st compare logic 296-300. Commands may be removed from the command queue 170 and issued on the bus 114 based on such signals. For example, a head pointer may point to the next entry 288 from which a command may be removed from the queue 170 and issued on the bus 114. If a signal output from the compare logic 294 corresponding to such entry 288 indicates the command has matured, such command may be removed from the queue 170 and issued on the bus 114. After the command is issued on the bus 114, the tag associated to the command may be freed so the tag may be assigned to a subsequently-received new command.

Alternatively, if the signal output from the compare logic 294 corresponding to such queue entry 288 indicates the command has not matured, such entry may be placed at the end of the queue and the head pointer may advance to the subsequent entry 288 in the queue 170. In this manner, issuance of the command on the bus 114 may be delayed for one or more cycles. In addition to maturity, the first processor 102 may issue a command on a bus 114 based on address collision dependencies of the command.

In this manner, the logic 186 may combine two or more read commands such that the read commands may be efficiently stored in the read command queue 170 (e.g., in a single queue entry 288). Further, the logic 186 may efficiently issue read commands on the bus 114. For example, the combined read command may be of a size (e.g., 256 Bytes) that matches or nearly matches the maximum size of a command that may be received on the bus 114 such that the bus bandwidth is used efficiently. Further, aging read commands in the manner described above allows for possible combination of two or more read commands to in the manner described above without indefinitely delaying other read commands from being issued on the bus 114. Although the first command combining and aging logic 186 coupled to the read command queue 170 is described above. The second command combining and aging logic 188 coupled to the write command queue 193 may be similar in structure and operation to the first command combining and aging logic 186.

Exemplary operation of the system 100 for issuing a command on a bus 114 is now described with reference to FIGS. 1A-2. The first processor 102 may receive one or more commands (e.g., I/O commands) from the second processor 104. Each command may be associated with (e.g., target or require access to) an address. Each command may be received in the I/O controller 108 and stored in the command queue 112. From the command queue 112, the command may be provided to the stream splitter logic 132. If the new command is a read command, the stream splitter logic 132 may channel the command to the read command queue 170. Alternatively, if the new command is a write command, the stream splitter logic 132 may channel the command to the write command queue 193. The stream splitter logic 132 (e.g., free tag assignment logic included therein) may assign a tag to the new command based on tag availability. The stream splitter logic 132 may employ numerical priority to assign a tag to the command. For example, assume the new command is a read command and the command pipeline logic 110 employs sixteen read tags Read_Tag 0-Read_Tag 15. If Read_Tag 0 and Read_Tag 1 are used and remaining read tags are free, the stream splitter logic 132 may assign the Read_Tag 2 to the new read command. However, the stream splitter logic 132 may assign tags in a different manner.

The command and address associated therewith may also be provided to the command combine logic 286 of the logic 186, 188 corresponding to the command. The address associated with the command may be compared with the age address ranges Age Address Range0-Age Address Range3 masked by the age address masks Age Address Mask0-Age Address Mask3, respectively, to determine an age rate AgeRate0-AgeRate3 for the command. Thus, the age rate may be picked from one of age rate registers 270-276 based on the command address and the address range (or masked version thereof) the command falls into. Such age rate may be copied from the age rate register 270-276 into the age rate register 290 corresponding to the tag assigned to the command. In this manner, the age rate will not change midstream if the processor performs an MMIO access (e.g., updates one or more of the values stored by the age rate registers 270-276 via the MMIO bus 200). Further, the age counter 292 corresponding to the tag may be reset to zero. In this manner, each command may be assigned an age of 0 when first placed in a command queue 170, 193. Such age may follow the command through the command pipeline logic 110.

Every cycle, the logic 186, 188 may be adapted to update (e.g., increment) the age of the command based on the aging rate. The logic 186, 188 may update the ages of all remaining commands in the queue based on based on respective aging rates in a similar manner. Thus, some commands may age faster, and therefore, mature sooner than other commands.

When the command reaches the top of the command queue 170, 193 (e.g., a first in, first out queue (FIFO)), the current age of the command may be compared, via the compare logic 294, against the predetermined maximum age stored by the command age register 252. In this manner, the logic 186, 188 may determine whether the command has been waiting in the queue 170, 193 long enough for potential combination with a successive contiguous command (e.g., whether the command has matured). After the command has matured, the command issue logic 302 may allow the command to be issued from the bus 114. More specifically, the command may be issued on the bus 114 once such command reaches the top of the command queue 170, 193.

Alternatively, if the command has not matured, the command issue logic 302 may prevent the command from being issued on the bus 114 until after the command reaches maturity. Therefore, if the command reaches the top of the command queue 170, 193 before the command reaches maturity, the command may be placed at the end of the command queue 170, 193.

While a command is waiting in the command queue 170, 193, if a successive command received by the first processor 102 may not be combined with the command (e.g., the successive command is associated with an address that is not contiguous with the address associated with the waiting command), the logic 186, 188 may update the age of the preceding command to the predetermined maximum age such that the command matures immediately. After such maturation, the preceding command may be issued on the bus.

A command may be combined with a successive command when combination conditions are met. For example, a command of a first size (e.g., 128 Bytes) may be combined with successive command of the first size when the command is associated with a first address defined on a first address boundary (e.g., a 256-Byte boundary) and the successive command is associated with a second address that is contiguous with the first address and defined on a second address boundary (e.g., a 128-Byte boundary). However, the above combination conditions are exemplary, and therefore, a larger or smaller number of and/or different combination conditions may be employed. The combined command may be of the second size (e.g., 256 Bytes) and associated with the first address. The combined command may be associated with the age of the first command. Similar to uncombined commands, the logic 186, 188 may increment the age of the combined command. After the combined command reaches maturity, the combined command may be issued on the bus 114 once such command reaches the top of the command queue 170, 193.

Alternatively, the processor 102 may not receive a successive command that may be combined with the queued command before the queued command reaches maturity (and reaches the top of the command queue 170, 193). Therefore, after the combined command reaches maturity and reaches the top of the command queue 170, 193, the command may be issued on the bus 114.

After issuing a command on the bus 114, the command issue logic 302 may wait for an indication from the bus 114 that the command is complete or nearly complete. When such indication is received, the command pipeline logic 110 may free the tag associated with the command such that the tag may be reused for another command.

In this manner, the command pipeline logic 110 may efficiently store commands in the command queues 170, 193. Further, the command pipeline logic 110 may efficiently issue commands on the bus 114. Although the above discussion focuses on issuance of commands on the bus 114 based on ages associated therewith, in some embodiments, the command pipeline logic 110 may issue commands on the bus based on address collision dependencies in addition to ages associated with commands.

In a conventional system, when a command reaches the top of a command queue, the command is issued via an interface on an internal bus (e.g., processor bus). The conventional system issues the command without waiting for the next contiguous command, and therefore, does not combine commands. Consequently, the conventional system fails to employ full capability of the bus (e.g., does not use the entire bus bandwidth).

In the present system, the first processor 102 may receive commands of a first size (e.g., 128 Bytes) from a second processor 104 via an I/O Interface 108. The commands are to be issued on a bus 114 which may receive commands of up to a second size (e.g., 256 Bytes). Thus, commands received from the second processor 104 may include up to 128 Bytes of data, and commands received by the bus 114 may include up to 256 Bytes of data. The present methods and apparatus may avoid the disadvantages of the conventional system by employing command aging to delay a command associated with a first address such that a successive command associated with a second address may be received, wherein the first and second addresses are contiguous, such that the two commands (e.g., received from the I/O interface) may be algorithmically combined into a larger command which may be issued on the bus 114. The larger combined command employs the bus bandwidth more efficiently than if the command associated with the first address is issued on the bus 114, and thereafter, if the successive command associated with the second address is issued on the bus 114 because the size of the combined command may be closer to the maximum command size that the bus 114 may receive.

As stated, the present system may separate received commands into read and write queues and track address collision dependencies of the commands. Consequently, two successive contiguous commands may become separated by many cycles (e.g., due to shared read/write command buffers in several stages of the command pipeline). Thus, the present methods and apparatus allow a command to catch up to a previously-received contiguous partner command so that the commands may be combined into a larger command which may take full advantage of the bus bandwidth.

The foregoing description discloses only exemplary embodiments of the invention. Modifications of the above disclosed apparatus and methods which fall within the scope of the invention will be readily apparent to those of ordinary skill in the art. For instance, in some embodiments, the read and write interfaces 182, 204 may include the command issue logic 302. Further, commands to two different sizes may be combined. Additionally, in some embodiments, more than two commands may be combined.

Accordingly, while the present invention has been disclosed in connection with exemplary embodiments thereof, it should be understood that other embodiments may fall within the spirit and scope of the invention, as defined by the following claims.

The invention claimed is:

1. A method of combining commands prior to issuing a command on a bus, comprising:
receiving a first command associated with a first address;
delaying the issue of the first command on the bus for a time period;
if a second command associated with a second address contiguous with the first address is not received before the time period elapses, issuing the first command on the bus after the time period elapses; and
if the second command associated with the second address contiguous with the first address is received before the first command is issued on the bus, combining the first and second commands into a combined command associated with the first address.

2. The method of claim 1 further comprising issuing the combined command on the bus.

3. The method of claim 2 wherein issuing the combined command on the bus includes:
delaying the issue of the combined command on the bus for one or more cycles;
for every cycle, incrementing an age assigned to the combined command by the age rate assigned to an address range referenced by the combined command address; and
after the age assigned to the combined command reaches a maximum age, issuing the combined command on the bus.

4. The method of claim 1 wherein delaying the issue of the first command on the bus for a time period includes:
assigning an initial age and an age rate to the first command when the first command is received;
delaying the issue of the first command on the bus for one or more cycles;
for every cycle, incrementing the initial age of the first command by the age rate; and
after the age of the first command reaches a maximum age, issuing the first command on the bus.

5. The method of claim 4 further comprising, if a second command associated with a third address that is not contiguous with the first address is received before the time period elapses, setting the age of the first command to the maximum age.

6. The method of claim 4 wherein the age rate employed to increment the age assigned to the first command is based on whether the first address is within a predetermined address range masked by a corresponding predetermined address range mask.

7. The method of claim 1 wherein:
the first command is of a first size;
the second command is of the first size; and
the combined command is of a second size that is larger than the first size.

8. The method of claim 1 further comprising storing the combined command in a single entry of a queue.

9. An apparatus for combining commands prior to issuing a command, comprising:
a bus; and
command pipeline logic coupled to the bus and adapted to:
receive a first command associated with a first address;
delay the issue of the first command on the bus for a time period;
if a second command associated with a second address contiguous with the first address is not received before the time period elapses, issue the first command on the bus after the time period elapses; and
if the second command associated with the second address contiguous with the first address is received before the first command is issued on the bus, combine the first and second commands into a combined command associated with the first address.

10. The apparatus of claim 9 wherein the command pipeline logic is further adapted to issue the combined command on the bus.

11. The apparatus of claim 10 wherein the command pipeline logic is further adapted to:
delay the issue of the combined command on the bus for one or more cycles;
for every cycle, increment an age assigned to the combined command by the age rate assigned to an address range referenced by the combined command address; and
after the age assigned to the combined command reaches a maximum age, issue the combined command on the bus.

12. The apparatus of claim 9 wherein the command pipeline logic is further adapted to:
assign an initial age and an age rate to the first command when the first command is received;
delay the issue of the first command on the bus for one or more cycles;
for every cycle, increment the initial age of the first command by the age rate; and
after the age of the first command reaches a maximum age, issue the first command on the bus.

13. The apparatus of claim 12 wherein the command pipeline logic is further adapted to, if a second command associated with a third address that is not contiguous with the first address is received before the time period elapses, set the age of the first command to the maximum age.

14. The apparatus of claim 12 wherein the age rate employed to increment the age assigned to the first command is based on whether the first address is within a predetermined address range masked by a corresponding predetermined address range mask.

15. The apparatus of claim 9 wherein:
the first command is of a first size;
the second command is of the first size; and
the combined command is of a second size that is larger than the first size.

16. The apparatus of claim 9 wherein the command pipeline logic is further adapted to store the combined command in a single entry of a queue.

17. A system for combining commands prior to issuing a command, comprising:
a first processor; and
a second processor coupled to the first processor and adapted to communicate with the first processor;
wherein the second processor includes an apparatus for issuing the command, having:
a bus; and
command pipeline logic coupled to the bus and adapted to:
receive a first command associated with a first address;
delay the issue of the first command on the bus for a time period;
if a second command associated with a second address contiguous with the first address is not received before the time period elapses, issue the first command on the bus after the time period elapses; and
if the second command associated with the second address contiguous with the first address is received before the first command is issued on the bus, combine the first and second commands into a combined command associated with the first address.

18. The system of claim 17 wherein the command pipeline logic is further adapted to issue the combined command on the bus.

19. The system of claim 18 wherein the command pipeline logic is further adapted to:
delay the issue of the combined command on the bus for one or more cycles;
for every cycle, increment an age assigned to the combined command by the age rate assigned to an address range referenced by the combined command; and
after the age assigned to the combined command reaches a maximum age, issue the combined command on the bus.

20. The system of claim 17 wherein the command pipeline logic is further adapted to:
assign an initial age and an age rate to the first command when the first command is received;
delay the issue of the first command on the bus for one or more cycles;
for every cycle, increment the initial age of the first command by the age rate; and
after the age of the first command reaches a maximum age, issue the first command on the bus.

21. The system of claim 20 wherein the command pipeline logic is further adapted to, if a second command associated with a third address that is not contiguous with the first address is received before the time period elapses, set the age of the first command to the maximum age.

22. The system of claim 20 wherein the age rate employed to increment the age assigned to the first command is based on whether the first address is within a predetermined address range masked by a corresponding predetermined address range mask.

23. The system of claim 17 wherein:
the first command is of a first size;
the second command is of the first size; and
the combined command is of a second size that is larger than the first size.

24. The system of claim 17 wherein the command pipeline logic is further adapted to store the combined command in a single entry of a queue.
